(19) United States
(12) Patent Application Publication
(10) Pub. No.: US 2019/0309539 A1
(43) Pub. Date: Oct. 10, 2019

(54) SMART LOCK SYSTEM WITH INTERIOR FACING DISPLAY SCREEN

(71) Applicant: Carrier Corporation, Palm Beach Gardens, FL (US)

(72) Inventors: Sumanth Kumar Mukundala, Palm Beach Gardens, FL (US); Adam Kuenzi, Palm Beach Gardens, FL (US); Steve Switzer, Palm Beach Gardens, FL (US)

(21) Appl. No.: 15/968,010

(22) Filed: May 1, 2018

(30) Foreign Application Priority Data
Apr. 5, 2018 (IN) 201811012908

(51) Int. Cl. E05B 17/22; G07C 9/00; E05B 17/00; E05B 65/00; E05B 35/00

(52) U.S. Cl. CPC E05B 17/226; G07C 9/00111; G07C 9/00031; G07C 9/00904; E05Y 2900/132; E05B 65/0032; E05B 35/007; E05Y 2400/82; E05B 17/0087

(57) ABSTRACT

A door lock system includes a controller including a processor and a memory. the controller is configured to interface with a smart lock. The door lock system also includes an exterior face plate on a first side of a door and an interior face plate on a second side of the door. The second side of the door faces an interior of a room while the door is in a closed position. The door lock system also includes a display screen disposed in the interior face plate. The display screen is connected to the controller and is an input device and an output device.

### CROSS-REFERENCE TO RELATED APPLICATION

This application claims priority to Indian Provisional Application No. 201811012908 filed on Apr. 5, 2018.

### TECHNICAL FIELD

The present disclosure relates generally to hotel locking systems, and more specifically to a smart lock system for a hotel or similar building, where the smart lock system includes an interior facing display screen on each lock.

### BACKGROUND

Hotels and other buildings utilizing temporary room reservations, such as conference centers, convention centers, and the like, typically prevent unauthorized access to rented or reserved rooms through the utilization of keycard locks and similar locking systems. When a user checks in or otherwise reserves the room the user is presented with an enabled key card that can unlock the door and allow access to the reserved room.

With the proliferation of smart technology, incorporation of additional features into the door locks themselves is becoming possible. Some current systems integrate the door lock with a network, and allow a user approaching the lock from the exterior of the room to enter via a short range mobile access (such as an Bluetooth connection through a mobile phone), entry of a room pin number, or similar systems. The user in such systems is still required to contact concierge services, or hang tags outside their door for standard room services such as “do not disturb”, “please clean”, and the like.

### SUMMARY OF THE INVENTION

In one exemplary embodiment a door lock system includes a controller including a processor and a memory and being configured to interface with a smart lock, an exterior face plate on a first side of a door, an interior face plate on a second side of the door, the second side of the door facing an interior of a room while the door is in a closed position, and a display screen disposed in the interior face plate, the display screen being connected to the controller, wherein the display screen is an input device and an output device.

In another example of the above described door lock system the controller is connected to at least one server remote from the door.

Another example of any of the above described door lock systems further includes a plurality of additional door lock systems, each of the additional door lock systems being disposed in different corresponding doors, and being connected to the at least one server.

In another example of any of the above described door lock systems the memory stores instructions for causing the display screen to display a set of functions to the user and for implementing at least one feature in response to the user selecting a function from the set of functions and wherein the set of functions includes at least one of a do not disturb function, a do not clean function, a guest copy card function, a child lock function, a checkout function, a cancel card function, a privacy function, and a block function.

In another example of any of the above described door lock systems the set of functions includes the privacy function, and wherein the door lock system is configured to set a status of the room to private in response to activation of the privacy function.

In another example of any of the above described door lock systems the set of functions includes the guest copy card function, the door lock system further includes a card read/write machine and wherein the guest copy card function is configured to enable an access card interfaced with the card read/write machine in response to the user selecting the guest copy card function.

In another example of any of the above described door lock systems the guest copy card function further includes a numerical limit, the controller is configured to prevent the guest copy card function from being activated after the guest copy card function has been engaged a number of times equal to the numerical limit.

In another example of any of the above described door lock systems the set of functions includes a cancel card function, the door lock system further includes a card read/write machine and wherein the cancel card function is configured to cancel a card interfaced with the card read/write machine in response to the user selecting the cancel card function.

In another example of any of the above described door lock systems the set of functions includes an audit function and wherein the controller is configured to cause the display to display at least a list of door opening events in response to a user selecting the audit function.

Another example of any of the above described door lock systems further includes a microphone input, the microphone input being connected to the controller and configured to activate at least one function in response to an audible command.

Another example of any of the above described door lock systems further includes a second display screen disposed in the exterior faceplate.

In another example of any of the above described door lock systems the controller is configured to limit functionalities prior to entry and validation of a security access code.

An exemplary method for securing a room using a smart lock includes displaying a set of self-service features on an interior facing display screen, and activating at least one of the self-service features in the set of self-service features in response to a user selecting the at least one of the self-service features.

In another example of the above described method for securing a room using a smart lock the set of self-service features includes at least one of a do not disturb function, a do not clean function, a guest copy card function, a child lock function, a checkout function, a cancel card function, an audit function and a block function.

In another example of any of the above described methods for securing a room using a smart lock the set of self-service features includes the guest copy card function, and wherein the smart lock is configured to write an access card in response to the user selecting the guest copy card function.

In another example of any of the above described methods for securing a room using a smart lock the guest copy card function includes a numerical limit, and wherein a controller in the smart lock is configured to prevent the guest copy card function from being activated after the guest copy card function has been engaged a number of times equal to the numerical limit.

In another example of any of the above described methods for securing a room using a smart lock displaying the set of self-service features on the interior facing display screen includes displaying a subset of available self-service feature prior to entry of a passcode.

In another example of any of the above described methods for securing a room using a smart lock activating the at least one of the self-service features comprises performing the self-service feature using a local processor of the smart lock.

In another example of any of the above described methods for securing a room using a smart lock activating the at least one of the self-service features comprises reporting the requested self-service feature to a remote server.

Another example of any of the above described methods for securing a room using a smart lock further includes notifying the user that the requested self-service feature has been performed by the remote server in response to receiving a confirmation from the remote server.

These and other features of the present invention can be best understood from the following specification and drawings, the following of which is a brief description.

### BRIEF DESCRIPTION OF THE DRAWINGS

FIGS. 1A and 1 B schematically illustrate an exemplary door lock system from an exterior facing side (1A) and an interior facing side (1B).

FIG. 2 schematically illustrates a door lock system integrating multiple doors.

FIG. 3 illustrates a method of operating a smart lock door system.

### DETAILED DESCRIPTION OF AN EMBODIMENT

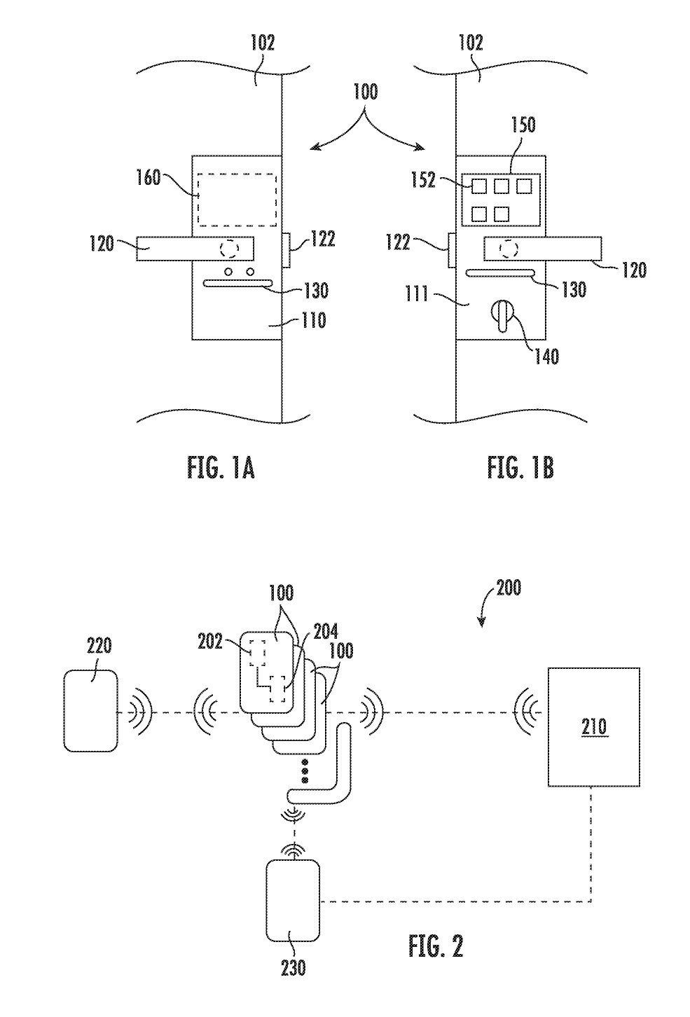

FIGS. 1A and 1B schematically illustrate a smart lock 100 for securing a rented room in a hotel, conference center, or similar type building. The smart lock 100 includes an exterior facing faceplate 110 (FIG. 1A) and an interior facing faceplate 111 (FIG. 1B). As used herein, interior facing refers to a surface that faces an interior of a room, and where the interior is the area of the room secured by the door. Contained within each smart lock 100 is a processor 202 and a memory 204 (illustrated in FIG. 2). Connected to the faceplates 110, 111 is a handle 120 for opening and closing the door 102. Rotating the handle 120 causes a linear motion of a latch 122, allowing the door to be opened. Alternative smart locks 100 can utilize any alternative unlatching and opening mechanism and the instant disclosure is not limited to the handle 120 and latch 122 configuration described herein.

Disposed within the exemplary smart lock 100 is a card reader 130 with a read/write functionality. The card reader 130 includes a magnet strip, RFID (radio frequency identification), NFC (near field communications chip) reader, or the like, and is configured to read and write data on an inserted card or a card held in close proximity to the faceplate 111. Depending on the self-service feature enabled within the given smart lock 100, the card reader 130 can also be configured to perform limited or unlimited write operations to the card. In alternative embodiments, the card reader 130 can be a local wireless signal, such as a bluetooth, and communicate with network enabled keycard devices, such as mobile phones including a designated app.

The interior facing faceplate 111 includes a deadbolt 140 configured to allow anyone inside the room to lock the door independently of the smart lock functionality. Also disposed on, or in, the interior facing faceplate 111 is a display screen 150. By virtue of the placement on or in the interior facing faceplate 111, the display screen 150 is only accessible to someone who has already gained access to the room secured by the smart lock 100. In some examples, the display screen 150 is an input/output device such as a touchscreen interface. In alternative examples, the display screen 150 can be purely output, and is accompanied by an input device such as a keypad or microphone configured to receive inputs and selections from elements displayed on the display screen 150. In the example of a microphone input, the smart lock 100 can be configured to receive and interpret audible commands according to any known protocol. Alternatively, the smart lock 100 can be configured to interface with existing audible command systems and utilize the command protocols of the existing audible command systems.

Accessible through the display screen 150 are a set of self-service features 152 that allow a hotel visitor who is authorized to access the room secured by the smart lock 100 to perform multiple functions at the door itself. Among the self-service features 152 are functions which previously would have required access to the hotel concierge services.

In some example embodiments, the exterior facing faceplate 110 can further include a display screen 160. The exterior facing display screen 160 presents information to staff and visitors.

With continued reference to the example of FIGS. 1A and 1B, FIG. 2 schematically illustrates multiple smart locks 100 in a centralized smart lock system 200. In the illustrated example each of the smart locks 100 is connected to a centralized remote server 210 via a wireless or wired connection through a network (not shown). In alternative examples, some or all of the smart locks 100 can operate independently of any remote server, and are not connected. Further included within each of the smart locks 100 is a processor 202 and a memory 204. The memory 204 stores instructions for directing operations of the processor 202 and facilitating multiple self-service features 152 (illustrated in FIG. 1B). Remote from, and able to connect to, any given smart lock 100 is one or more access component 220. The access component 220 can be a magnetic striped key card, an NFC device, a mobile phone including an access application, or any similar device or component.

In addition to the access component 220 a staff access component 230 held by one or more authorized staff member is capable of interfacing with the smart locks 100. As with the access component 220, the staff access component 230 can be a magnetic striped key card, an RFID or NFC device, a mobile phone including an access application, or any similar device and is configured to grant access to all, or a subset, of rooms secured by the smart locks 100.

With reference again to FIGS. 1A and 1B, the interior facing display screen 150 of any given smart lock 100 can be further secured with an access code or PIN (personal identification number) set by the authorized visitor upon initial access to the room secured by the smart lock 100. By setting such a security feature, the authorized visitor can prevent hotel staff, cleaning services, and anyone else who may be entering the room for a legitimate reason from accessing the self-service features 152 of the smart lock 100. Alternatively, the accessing of the self-service features 152 may be blocked until the smart lock 100 has been accessed by an access component 220 associated with the guest. Further, the self-service features 152 provided may vary depending on whether a guest access component 220 has been provided, a staff access component 230 has been provided, or no access component has been provided.

With regards to the self-service features 152, the features 152 can include, among other possible features, a do not disturb function, a do not clean function, a guest copy card function, an audit function, a child lock function, a checkout function, a cancel card function and a block function. In some embodiments, additional functions may be included as well. Further, depending on the configuration of the smart lock 100, some or all of these self-service features 152 can be performed locally at the smart lock 100 using the memory 204 and processors 202 within the smart lock 100. Alternatively, some of the self-service features 152 can be reported to a centralized remote server 210 when requested by the authorized accessor and the remote server 210 can perform the requested self-service feature 152.

When in a secured state (e.g. no pin or security code has been entered into the display screen 150) the selection of self-service features 152 can be limited to those only relevant to housekeeping, or similar roles. Further, the controller 202 and memory 204 can store instructions to limit access to the self-service features 152 based on the authorization level of the staff user entering the room. By way of example, a housekeeper entering the room may be limited to accessing a do not disturb function and a cleaning request function, whereas a manager level staff member may be allowed access to more of the self-service features 152 including a check out function, an audit function, and the like.

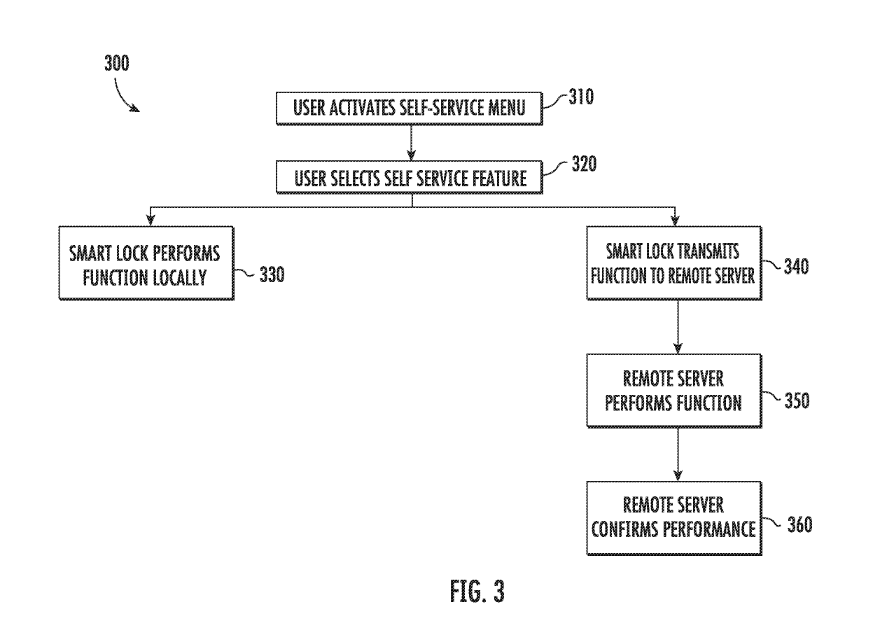

With continued reference to FIGS. 1A, 1B and 2, FIG. 3 schematically illustrates an example method 300 of operating a smart lock 100. Initially, upon accessing a reserved room, the user (alternatively referred to as an authorized visitor) activates a self-service feature menu displayed on the interior facing display screen 150 in a “User Activates Self-Service Menu” step 310. The activation can be achieved via touchscreen interface on the display screen 150, a voice activated command interface including a microphone, a keypad, or any similar activation sequence. Once activated, the user is able to select a self-service feature from the list of available self-service features in a “User Selects Self-Service Feature” step 320.

After the self-service feature 152 has been selected, the processor 202 in the smart lock 100 determines if the selected self-service feature 152 can be performed locally, or if the self-service feature 152 must be performed via a remote server. For services that can be performed locally, such as a copy card service, a do not disturb notification, and the like, the processor 202 performs the selected function according to instructions stored in the memory 204 in a “Smart Lock Performs Function Locally” step 330.

If the processor 202 determines that the smart lock 100 needs to communicate with the remote server 210 to perform the function, or if the self-service feature 152 needs to be performed via the remote server 210, such as with a check out function, then the smart lock 100 transmits the requested function to the remote server 210 in a “Smart Lock Transmits Function to Remote Server” step 340. Once the transmitted function has been received by the remote server 210, the remote server 210 performs the self-service feature 152 in a “Remote Server Performs Function” step 350. Optionally, once the remote server 210 has performed the function, the remote server 210 can transmit a confirmation that the self-service feature 152 has been successfully completed to the smart lock 100 in a “Remote Server Confirms Performance” step 360, and the smart lock 100 can provide an audio or visual indication that the function has been performed.

With reference to all of the Figures, the following is a non-exhaustive description of exemplary self-service features 152 that can be included in, and are enabled by, the smart lock 100.

A first exemplary self-service feature 152 is a do not disturb function. When a guest selects the do not disturb feature from the self-service features, the processor 202 updates a status of the room to “do not disturb”. This status update can include transmitting the status to the remote server, altering a display screen 160 on an exterior facing faceplate 110 to state do not disturb, or providing a notification to any approaching hotel staff that the guest has selected do not disturb. The do not disturb self-service feature 152 can be set to last until the user checks out, for 24 hours, until they open the door, or for any designated limit depending on the needs of management or the user.

Similarly, when a guest selects a cleaning self-service feature, the processor 202 updates a status of the room to no cleaning, or to indicate the specific areas where cleaning is requested, and the notification of the updated status is provided to the management in the same manner as the do not disturb feature described above on one or both of the display screens 150, 160.

Another exemplary self-service feature 152 facilitated by the smart lock 100 is a guest copy card self-service feature 152. The guest copy card function allows the guest to create additional room access cards using the smart lock 100 itself. The memory 204 can include a preset limit on the number of room access cards that can be created during a stay, on the number that can be active at any given time, or any similar limits on the creation of new access cards or credentials. Access cards may be provided on the inside of the room for the convenience of the authorized visitor or the authorized visitor may bring their own card.

When the user selects the copy card self-service feature 152, the display screen 150 prompts the user to present a blank card able to be written. The card can be any type of key card corresponding to the card reader 130 readable and writeable by the smart lock 100, including an NFC enabled card and a magnetic stripe card. Once presented with the card, the card reader 130 encodes the blank card with room access information, allowing the card to grant access to the room as with any other key card. Further, as with a standard key card encoded by concierge services, the blank key cards cease granting access to the room when they are canceled or expire.

In another alternative the user can select the privacy self-service feature 152. The privacy self-service feature 152 operates in a similar manner to the do not disturb self-service feature, and updates the remote server 210, as well as any staff attempting to access the room secured by the smart lock 100, with a notification that the current resident of the room wishes to remain private and access to the room is denied unless the staff has access rights configured to override privacy, for example. In some examples, the privacy function can include an on mode and an automatic mode.

When the on mode is engaged, the room will be set to privacy until the user engages the smart lock 100 by either exiting or entering the room. At which time, if the user wishes to maintain the privacy mode, the user must re-engage the privacy mode self-service feature 152. In contrast, when the automatic mode is engaged, the smart lock 100 remains in the privacy mode of operations until the user either checks out, or manually turns off the privacy mode.

Another exemplary self-service feature 152 is an audit function. During standard operations, the smart lock 100 maintains a list of each credential that has accessed the room and a timestamp of that access. The list can be either stored locally in the smart lock memory 204, or remotely at the remote server 210. When the user selects the audit self-service feature 152, the screen 150 displays a listing of each room access and the corresponding credential within a time frame specified by the user. In some examples, the audit function can be limited in access to only the user of a given room, limited to a duration of a stay, or any similar limitation. In alternative examples, the user and management level staff can have access to the audit function of a given smart lock 100.

Another exemplary self-service feature 152 is a child lock function. The child lock self-service feature 152 engages a child lock mode within the smart lock 100. While in the child lock mode, activation of the handle or other door opening mechanisms from the room interior does not allow the door secured by the smart lock 100 to be opened. In some examples, the smart lock 100 can be further integrated with a fire alarm, security system, or other evacuation notice system and allow for the “child lock” to be overridden in the case of an emergency evacuation. The interface can be through an internal network, the remote server 210, the internet, or via any other known interfacing.

Another exemplary self-service feature 152 that can be incorporated in the smart lock 100 is a check out function. When a user selects the checkout function, the smart lock 100 communicates with the remote server 210 and completes a check out process allowing the user to check out of the room without requiring a visit to concierge services. In some exemplary systems, engaging the checkout self-service feature 152 will deactivate the credentials of any access card, mobile device applications, and similar access components as part of the checkout function. Further, in the case that a card or device cannot be actively canceled, engaging the checkout self-service feature 152 informs the smart lock 100 that the room is in a checked out state, and the smart lock 100 can prevent access from any current non-staff access card until such time as the management or staff updates the smart lock 100 or encodes cards for the next authorized visitor.

Another exemplary self-service feature 152 is a cancel card function. The cancel card function uses the write features of the card reader 130 to override or deactivate a card presented by the authorized visitor.

While described above as including a pre-selected list of self-service features 152, one of skill in the art will appreciate that all or some of the described self-service features may be inapplicable in any given implementation of the smart lock. Similarly, additional self-service features may be desirable in an implementation, and may be included as well. By way of example, a taxi call feature could be added in some systems.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A door lock system comprising:
a controller including a processor and a memory and being configured to interface with a smart lock;
an exterior face plate on a first side of a door;
an interior face plate on a second side of the door, the second side of the door facing an interior of a room while the door is in a closed position; and
a display screen disposed in said interior face plate, the display screen being connected to the controller, wherein the display screen is an input device and an output device.

2. The door lock system of claim 1, wherein the controller is connected to at least one server remote from the door.

3. The door lock system of claim 2, further comprising a plurality of additional door lock systems, each of said additional door lock systems being disposed in different corresponding doors, and being connected to the at least one server.

4. The door lock system of claim 1, wherein the memory stores instructions for causing the display screen to display a set of functions to the user and for implementing at least one feature in response to the user selecting a function from the set of functions and wherein the set of functions includes at least one of a do not disturb function, a do not clean function, a guest copy card function, a child lock function, a checkout function, a cancel card function, a privacy function, and a block function.

5. The door lock system of claim 4, wherein the set of functions includes the privacy function, and wherein the door lock system is configured to set a status of the room to private in response to activation of the privacy function.

6. The door lock system of claim 4, wherein the set of functions includes the guest copy card function, the door lock system further includes a card read/write machine and wherein the guest copy card function is configured to enable an access card interfaced with said card read/write machine in response to the user selecting the guest copy card function.

7. The door lock system of claim 6, wherein the guest copy card function further includes a numerical limit, the controller is configured to prevent the guest copy card function from being activated after the guest copy card function has been engaged a number of times equal to the numerical limit.

8. The door lock system of claim 4, wherein the set of functions includes a cancel card function, the door lock system further includes a card read/write machine and wherein the cancel card function is configured to cancel a card interfaced with said card read/write machine in response to the user selecting the cancel card function.

9. The door lock system of claim 3, wherein the set of functions includes an audit function and wherein the controller is configured to cause the display to display at least a list of door opening events in response to a user selecting the audit function.

10. The door lock system of claim 1, further comprising a microphone input, the microphone input being connected to the controller and configured to activate at least one function in response to an audible command.

11. The door lock system of claim 1, further comprising a second display screen disposed in the exterior faceplate.

12. The door lock system of claim 1, wherein the controller is configured to limit functionalities prior to entry and validation of a security access code.

13. A method for securing a room using a smart lock comprising:
displaying a set of self-service features on an interior facing display screen; and
activating at least one of the self-service features in the set of self-service features in response to a user selecting the at least one of the self-service features.

14. The method of claim 13, wherein the set of self-service features includes at least one of a do not disturb function, a do not clean function, a guest copy card function, a child lock function, a checkout function, a cancel card function, an audit function and a block function.

15. The method of claim 14, wherein the set of self-service features includes the guest copy card function, and wherein the smart lock is configured to write an access card in response to the user selecting the guest copy card function.

16. The method of claim 15, wherein the guest copy card function includes a numerical limit, and wherein a controller in the smart lock is configured to prevent the guest copy card function from being activated after the guest copy card function has been engaged a number of times equal to the numerical limit.

17. The method of claim 13, wherein displaying the set of self-service features on the interior facing display screen includes displaying a subset of available self-service feature prior to entry of a passcode.

18. The method of claim 13, wherein activating the at least one of the self-service features comprises performing the self-service feature using a local processor of the smart lock.

19. The method of claim 13, wherein activating the at least one of the self-service features comprises reporting the requested self-service feature to a remote server.

20. The method of claim 19, further comprising notifying the user that the requested self-service feature has been performed by the remote server in response to receiving a confirmation from said remote server.

21. The door lock system of claim 4, wherein the set of functions includes the child lock function, and the door lock system is configured such that activation of an interior facing door opening mechanism is prevented from allowing the door to open while the child lock function is engaged.

22. The door lock system of claim 21, wherein the door lock system is communicatively connected to an evacuation notice system and configured such that activation of the evacuation notice system disengages the child lock function.
